(19) United States
(12) Patent Application Publication
(10) Pub. No.: US 2017/0129385 A1
(43) Pub. Date: May 11, 2017

(54) Cargo Securement Device

(71) Applicant: Ricardo Galan, Houston, TX (US)

(72) Inventor: Ricardo Galan, Houston, TX (US)

(21) Appl. No.: 15/281,040

(22) Filed: Sep. 29, 2016

Related U.S. Application Data
(60) Provisional application No. 62/235,308, filed on Sep. 30, 2015.

(51) Int. Cl. B60P 7/135

(52) U.S. Cl. CPC B60P 7/135

(57) ABSTRACT

A cargo securement device for securing loads to flatbed trailers is provided. The cargo securement device comprises an extendable bar member having a first end and a second end. An angled tip is formed at the second end of the extendable bar member. A shoulder is formed at the second end of the extendable bar member. The extendable member provides strength and leverage needed to adequately secure loads allowing a quick and complete securement process.

### CLAIM OF PRIORITY

This patent application claims priority under 35 USC 119 (e) (1) from U.S. Provisional Patent Application Ser. No. 62/235,308 filed Sep. 30, 2015, of common inventorship herewith entitled, “King Bar,” which is incorporated herein by reference as though the same were set forth in its entirety.

### FIELD OF THE INVENTION

The present invention pertains to the field of trucking load accessories, and more specifically to the field of cargo securement devices.

### BACKGROUND OF THE INVENTION

A flatbed truck is an articulated or rigid type of truck that has an entirely flat and level bed with no sides or roof. Allowing for quick and easy loading of goods, a flatbed truck is used to transport heavy loads that are indelicate or invulnerable to precipitation. Such loads may be construction equipment or abnormal loads that require more space than is available on a truck with a closed body. Since there is no enclosure, properly securing flatbed cargo is essential to prevent items from shifting, spilling, blowing or falling from the flatbed. Even for a seasoned trucker, securing cargo on a flatbed trailer can be a daunting challenge. Manually stretching straps or chains up and over a high and uneven collection of cargo is time consuming and laborious. Many truckers who utilize flatbeds experience painful back and muscle injuries as the strength and stretching required for securing such loads takes a hard toll on the body.

The prior art has put forth several designs for cargo securement devices. Among these are:

U.S. Pat. No. 5,524,505 to Phillip G. Lawrence describes a chain binder extension handle comprising an engagement member that fits on a chain binder handle. A gripping member is pivotally mounted on the engagement member for limited angular movement between an aligned position and a skewed position with respect to the engagement member. A coil spring urges the members toward their aligned positions and resiliently resists the bending force exerted on the handle as the chain binder snaps into or out of a locked position.

U.S. Pat. No. 4,756,181 to Dallas A. Appelgren describes a method of making and using a tool for use in locking and unlocking a load enveloping chain binder. The tool is formed by cutting off the front end of a cylindrical pipe section at an acute angle to provide a leading edge on one side of the front end and an opposite trailing edge. One side of the pipe section is creased rearwardly of both the leading and trailing edges to form an axially sloping, internal, piloting and stop projection against which the handle of the chain binder is received, and while simultaneously squeezing the lateral sides of the pipe section to provide a handle rearwardly of the internal projection.

U.S. Pat. No. 3,119,278 to Lee Simpson Elmer describes a manually operable tool which is adapted to be arranged in engagement with the handle of a load binder or load tightener, whereby the load binder is operated with increased safety and facility. A further object is to provide a safety leverage extension or tool which is adapted to be used in conjunction with load binders that are used for securing a load such as a load of logs, pipes or other members in position. The tool of the present invention is especially suitable for preventing injury to workmen or the like when the handle of the load binder moves past dead center. Still another object is to provide such a safety leverage extension or tool which is rugged in structure and foolproof in use and which is economical to manufacture and efficient in operation.

None of these prior art references describe the present invention.

### SUMMARY OF THE INVENTION

It is an object of the present invention to provide an extendable assistive device particularly configured and constructed for securing loads to flatbed trailers.

The present invention is a cargo securement device for securing loads to flatbed trailers. The cargo securement device comprises an extendable bar member having a first end and a second end. An angled tip is formed at the second end of the extendable bar member. A shoulder is formed at the second end of the extendable bar member. The extendable member provides strength and leverage needed to adequately secure loads allowing a quick and complete securement process.

In addition, the present invention is a method for securing loads to flatbed trailers. The method comprises providing an extendable bar member having a first end and a second end, forming an angled tip at the second end of the extendable bar member, forming a shoulder at the second end of the extendable bar member, and providing strength and leverage needed to adequately secure loads allowing a quick and complete securement process.

The present invention further includes a cargo securement device for securing loads to flatbed trailers. The cargo securement device comprises a first bar member having a first end and a second end and a second bar member having a first end and a second end. The second end of the first bar member is slidably receivable within the first end of the second bar member. A securing mechanism releasably secures the first bar member to the second bar member. A grip device mounted at the second end of the first bar member and an angled tip formed at the first end of the second bar member. A shoulder is formed at the second end of the second bar member. The extendable member provides strength and leverage needed to adequately secure loads allowing a quick and complete securement process.

### BRIEF DESCRIPTION OF THE DRAWINGS

FIG. 1 is a perspective view illustrating a cargo securement device, constructed in, accordance with the present invention, with the cargo securement device being in a retracted position.

FIG. 2 is a perspective view illustrating the cargo securement device, constructed in accordance with the present invention, with the cargo securement device being in an extended position.

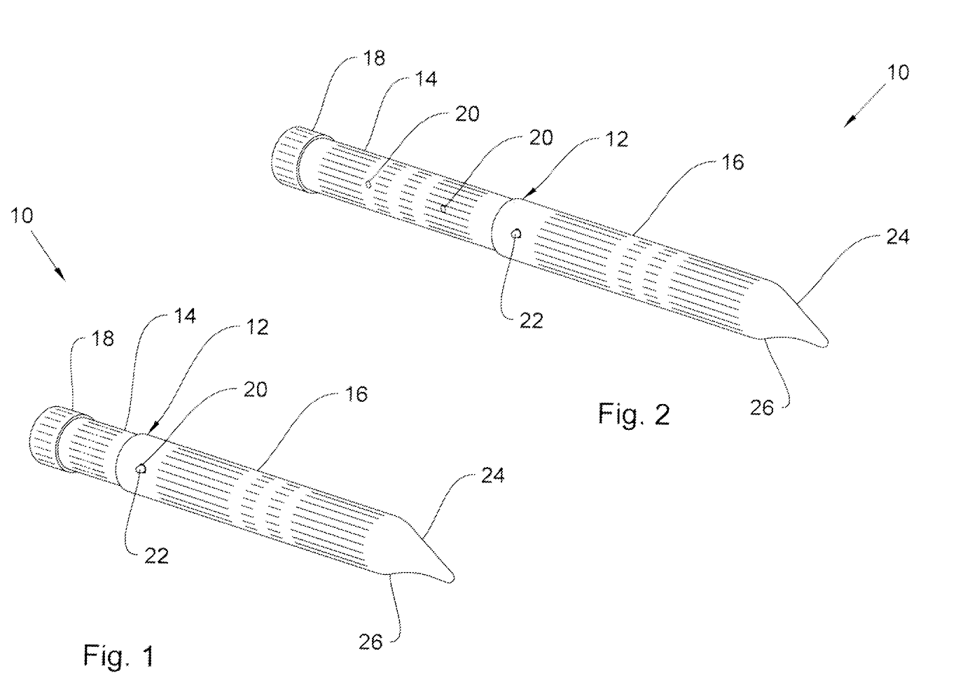

### DETAILED DESCRIPTION OF THE INVENTION

The present invention, hereinafter referred to as the Cargo Securement Device, indicated general at 10, is an extendable assistive device particularly configured for securing loads to flatbed trailers. The Cargo Securement Device 10 provides truck drivers with an easier, less labor intensive means of successfully completing this securement task. Using the Cargo Securement Device 10, truckers are able to quickly complete the securement process with little effort and without injury.

The Cargo Securement Device 10 of the present invention comprises a two-piece, extendable bar member 12 having a first bar member 14 and a second bar member 16. The first bar member 14 has a first end and a second end and the second bar member 16 has a first end and a second end. The second end of the first bar member 14 is slidably receivable within the first end of the second bar member 16 and releasably secured in a desired position, as will be described below. In practice, the extendable bar member 12 extends from approximately three (3′) feet to five (5′) feet in length although having an extendable bar 12 extending less than or greater than the length set forth herein is within the scope of the present invention.

In a preferred embodiment, the extendable bar member 12 of the Cargo Securement Device 10 of the present invention is substantially cylindrical in shape and constructed from a durable, heavy duty, steel material. It should be noted that it is within the scope of the present invention for the extendable bar 12 to have a different shape and be constructed from a different material.

The first end of the second bar member 16 of the extendable bar member 12 of the Cargo Securement Device 10 of the present invention is preferably sheathed in a rubberized grip 18. The rubberized grip 18 provides a comfortable, sure hold, and inhibits the hand from slipping off the extendable bar member 12 when the Cargo Securement Device 10 is in use.

The first bar member 14 and the second bar member 16 of the extendable bar member 12 of the Cargo Securement Device 10 of the present invention include an aperture 20 or a series of apertures 20. As the first bar member 14 slides into the second bar member 16, the aperture or apertures 20 formed in the first bar member 14 will overlap with the aperture or apertures 20 formed in the second bar member 16. A locking pin 22 is receivable within at least one set of the overlapped apertures 20 thereby releasably securing the position of the first bar member 14 relative to the second bar member 16 and releasably setting the desired length of the extendable bar member 12.

In addition, the Cargo Securement Device 10 of the present invention preferably includes a track system associated with the first bar member 14 and the second bar member 16 such that the first bar member 14 does not axially rotate relative to the second bar member 16. Furthermore, with the track system, the aperture or series of apertures 20 on the first bar member 14 will remain aligned with the aperture or series of apertures 20 on the second bar member 16.

Additionally, the second end of the first bar member 14 of the extendable bar member 12 of the Cargo Securement Device 10 of the present invention contains a brace that is conducive to easily affixing chains and straps to the extendable bar member 12. In addition, the second end of the first bar member 14 of the Cargo Securement Device 10 is used to tighten a cargo load strap. The second end of the end of the first bar member 14 includes an angled tip 24. The angled tip 24 tapers downward from the second end of the first bar member 14 to a substantial point. A shoulder or raised edge 26 is formed at the second end of the first bar member 14 for locking into the hole of a flatbed trailer winch. Once the angled tip 24 enters the hole and downward pressure is applied, the raised edge 26 holds the Cargo Securement Device 10 in place. Simple in configuration and construction yet effective in application, the Cargo Securement Device 10 is quickly employable by extending or retracting it to accommodate the size of the load to be carried.

The Cargo Securement Device 10 of the present invention provides strength and leverage needed to adequately strap or chain everything from construction materials to large coils of cable and lengths of steel pipe. The extension capability effectively relieves strain and tension on a trucker's back, arm and leg muscles, preventing debilitating injuries which sometimes result in a trucker's inability to work. Containing a rubber handle 18, the Cargo Securement Device 10 remains secure in one's hands while it is in use, providing a sure grip at all times.

While the Cargo Securement Device 10 of the present invention is instrumental in significantly reducing the amount of time required to strap in cargo, the Cargo Securement Device 10 also gives truckers peace of mind that their loads are completely secured. In its collapsed state, the Cargo Securement Device 10 is conveniently stored and readily available when need. Fabricated of durable, high quality materials and components, the Cargo Securement Device 10 will provide years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A cargo securement device for securing loads to flatbed trailers, the cargo securement device comprising:
an extendable bar member having a first end and a second end;
an angled tip formed at the second end of the extendable bar member; and
a shoulder formed at the second end of the extendable bar member;
wherein the extendable member provides strength and leverage needed to adequately secure loads allowing a quick and complete securement process.

2. The cargo securement device of claim wherein the extendable bar member comprises:
a first bar member having a first end and a second end;
a second bar member having a first end and a second end;
wherein the second end of the first bar member is slidably receivable within the first end of the second bar member.

3. The cargo securement device of claim 2 wherein the first bar member is releasably securable to the second bar member.

4. The cargo securement device of claim 3 wherein the first bar member has a series of first apertures and the second bar member has a series of second apertures, the first apertures alignable with the second apertures.

5. The cargo securement device of claim 4 and further comprising:
at least one locking pin receivable within each of the aligned, overlapping first and second apertures.

6. The cargo securement device of claim 2 and further comprising:
a track system associated with the first bar member and the second bar member such that the first bar member is axially non-rotatable relative to the second bar member.

7. The cargo securement device of claim 1 wherein the extendable bar is substantially cylindrical in shape.

8. The cargo securement device of claim 1 wherein the second end of the extendable bar member is sheathed in a rubberized grip.

9. The cargo securement device of claim 1 wherein the angled tip tapers downward from the second end of the extendable bar member to a substantial point.

10. The cargo securement device of claim 1 and further comprising:
a brace positioned at the second end of the first bar member.

11. A method for securing loads to flatbed trailers, the method comprising:
providing an extendable bar member having a first end and a second end;
forming an angled tip at the second end of the extendable bar member;
forming a shoulder at the second end of the extendable bar member; and
providing strength and leverage needed to adequately secure loads allowing a quick and complete securement process.

12. A cargo securement device for securing loads to flatbed trailers, the cargo securement device comprising:
a first bar member having a first end and a second end;
a second bar member having a first end and a second end, the second end of the first bar member slidably receivable within the first end of the second bar member;
securing means for releasably securing the first bar member to the second bar member;
a grip device mounted at the second end of the first bar member;
an angled tip formed at the first end of the second bar member; and
a shoulder formed at the second end of the second bar member;
wherein the extendable member provides strength and leverage needed to adequately secure loads allowing a quick and complete securement process.

13. The cargo securement device of claim 12 wherein the first bar member has a series of first apertures and the second bar member has a series of second apertures, the first apertures alignable with the second apertures.

14. The cargo securement device of claim 13 and further comprising:
at least one locking pin receivable within each of the aligned, overlapping first and second apertures.

15. The cargo securement device of claim 12 and further comprising:
a track system associated with the first bar member and the second bar member such that the first bar member is axially non-rotatable relative to the second bar member.

16. The cargo securement device of claim 12 wherein the extendable bar is substantially cylindrical in shape.

17. The cargo securement device of claim 12 wherein the angled tip tapers downward from the second end of the extendable bar member to a substantial point.

18. The cargo securement device of claim 12 and further comprising:
a brace positioned at the second end of the first bar member.
